(19) United States
(12) Patent Application Publication
(10) Pub. No.: US 2015/0096396 A1
(43) Pub. Date: Apr. 9, 2015

(54) BALL SCRW CAPABLE OF SENSING PARALLELISM IN REAL TIME

(71) Applicant: National Chung Cheng University, Chia-Yi County (TW)

(72) Inventors: Yeau-Ren JENG, Tainan City (TW); Yu-Xian HUANG, Tainan City (TW)

(73) Assignee: National Chung Cheng University, Chia-Yi County (TW)

(21) Appl. No.: 14/047,321

(22) Filed: Oct. 7, 2013

(51) Int. Cl. F16H 25/22

(52) U.S. Cl. CPC F16H 25/2204
USPC 74/424.81

(57) ABSTRACT

A ball screw is formed of a screw rod, two screw nuts, a link, a plurality of balls, and at least two parallelism sensors. The screw nuts are sleeved onto the screw rod and are connected with each other via a link to define a spiral path therebetween. The spiral path is linked with an internal circulatory passage of each screw nut for receiving a plurality of balls. The two parallelism sensors are oppositely mounted between the two screw nuts and surround the screw rod for sensing the preload between the two screw nuts to figure out whether the parallelism of the screw rod after the assembly is deviated or not. In this way, monitoring the voltage value outputted from the parallelism sensors can monitor the parallelism of the screw rod in real time after the assembly.

### BACKGROUND OF THE INVENTION

1. Field of the Invention

The present invention relates generally to a ball screw and more particularly, to a ball screw capable of sensing parallelism in real time.

2. Description of the Related Art

A ball screw is a common component in precise positioning and keeps rolling to serve as the power transmission interface between a screw rod and a screw nut for much reduction of frictional resistance generated while the screw nut is working. When it is intended to install the ball screw into a machine, an experienced technician is usually needed to calibrate the parallelism of the screw rod beforehand. However, if an assembly technician does not have sufficient experience, he parallelism of the screw rod is subject to deviation and in this way, after the ball screw is working for a long time, the service life of the ball screw can be adversely affected.

Taiwan Patent No. 1407026 disclosed a method diagnostic of preload ineffectiveness of a ball screw and a device based on the method, in which a voiceprint signal generated while the ball screw is working can be filtered by empirical mode decomposition (EMD), then processed by Hilbert-Huang transform (HHT) to generate Hilbert-Huang spectrum (HHS), next processed by multi-scale entropy extraction to generate multi-scale entropy complexity mode, and after the raw multi-scale entropy complexity mode and the current multi-scale entropy complexity mode are compared, whether the preload of the ball screw disappears or not can be effectively diagnosed for the user to monitor the ball screw. However, such method fails to directly measure the parallelism of the screw rod after the assembly and can do nothing but indirectly measure the preload. Therefore, the method fails to come up with the accurate measuring result of the parallelism of the screw rod.

### SUMMARY OF THE INVENTION

The primary objective of the present invention is to provide a ball screw which can sense the parallelism of a screw rod and the sensing accuracy of which is not easily adversely affected by external interference.

The foregoing objective of the present invention is attained by the ball screw formed of a screw rod, two screw nuts, a link, a plurality of balls, and two parallelism sensors. The screw rod includes an external thread, Each of the screw nuts is sleeved onto the screw rod and includes an internal circulatory passage and an internal thread at its internal periphery. A spiral path is formed between the internal threads and the external thread and linked. with the internal circulatory passage of each screw nut. Each of the screw nuts includes a keyway at its external periphery. The link is mounted inside the two keyways for linking the two screw nuts. The balls are rollingly mounted to the spiral path and each of the internal circulatory passages, for reducing frictional resistance generated while the screw nuts are working relative to the screw rod. The two parallelism sensors are oppositely mounted between the two screw nuts and centrally around the screw rod for sensing whether the preload between the two screw nuts is changed, after the ball screw is assembled, to indirectly figure out whether the screw rod keeps preferable parallelism.

### BRIEF DESCRIPTION OF THE DRAWINGS

FIG. 1 is a perspective view of a first preferred embodiment of the present invention.

FIG. 2 is an exploded view of the first preferred embodiment of the present invention.

FIG. 3 is a plane view of the parallelism sensor of the first preferred embodiment of the present invention.

FIG. 4 sectional view of the first preferred embodiment of the present invention.

FIG. 5 is a sectional view taken along a line 5-5 indicated in FIG. 4.

FIG. 6 is an exploded view of a second preferred embodiment of the present invention.

### DETAILED DESCRIPTION OF PREFERRED EMBODIMENTS

Structural features and desired effects of the present invention will become more fully understood by reference to two preferred embodiments given hereunder. However, it is to be understood that these embodiments are given by way of illustration only, thus are not limitative of the claim scope of the present invention.

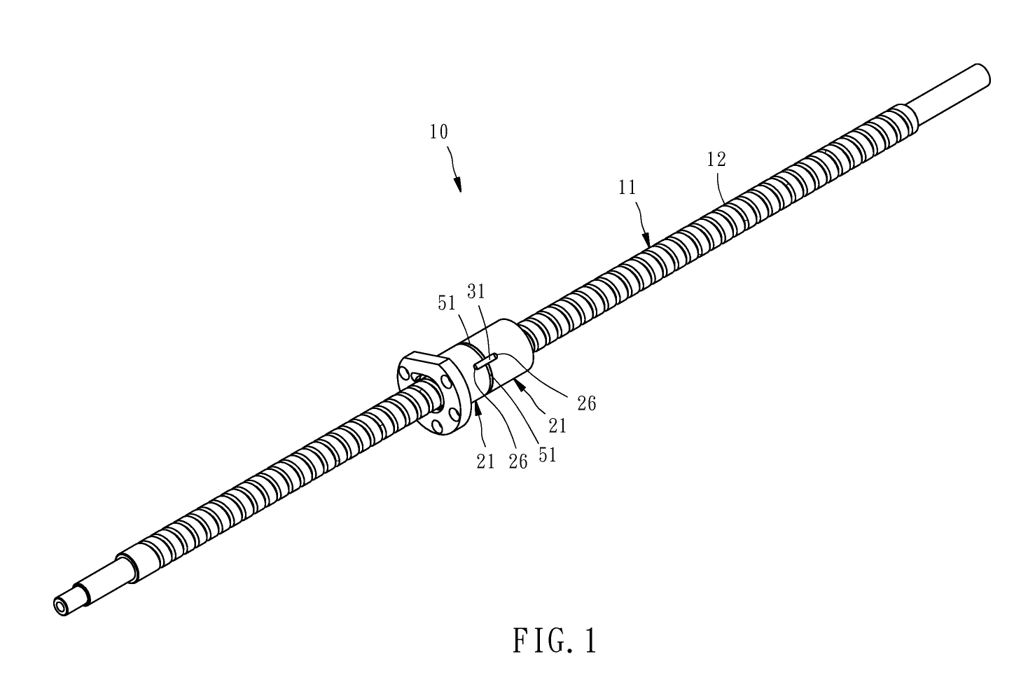

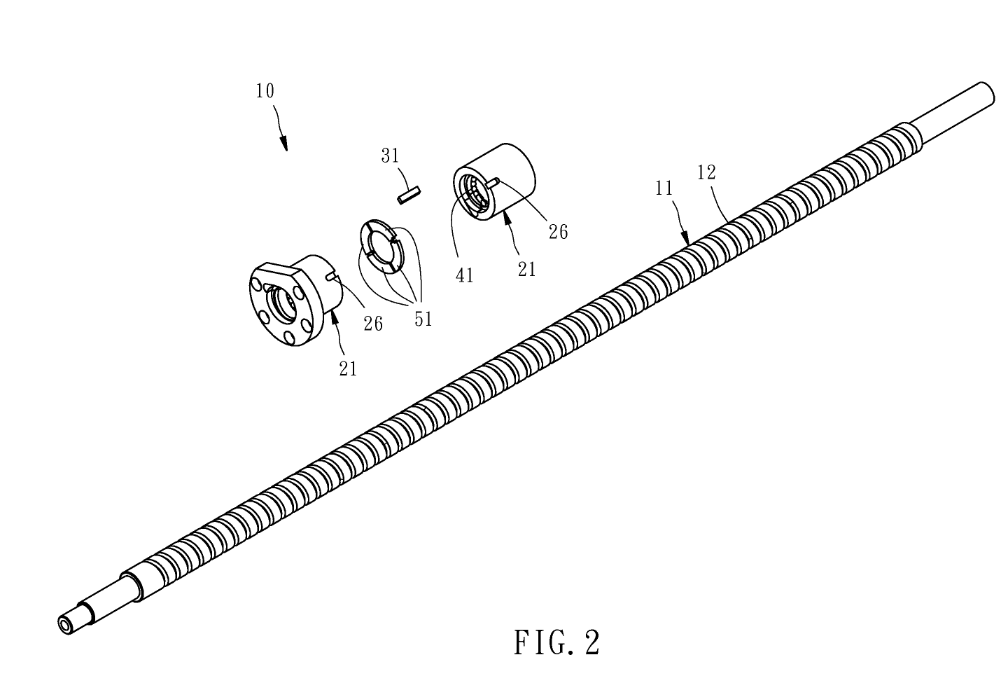

Referring to FIGS. 1 and 2, a ball screw 10 constructed according to a first preferred embodiment of the present invention is formed of a screw rod 11, two screw nuts 21, a link 31, a plurality of balls 41, and four parallelism sensors 51. The detailed descriptions and operations of these elements as well as their interrelations are recited in the respective paragraphs as follows.

The screw rod 11 includes an external thread 12 formed at an external periphery thereof.

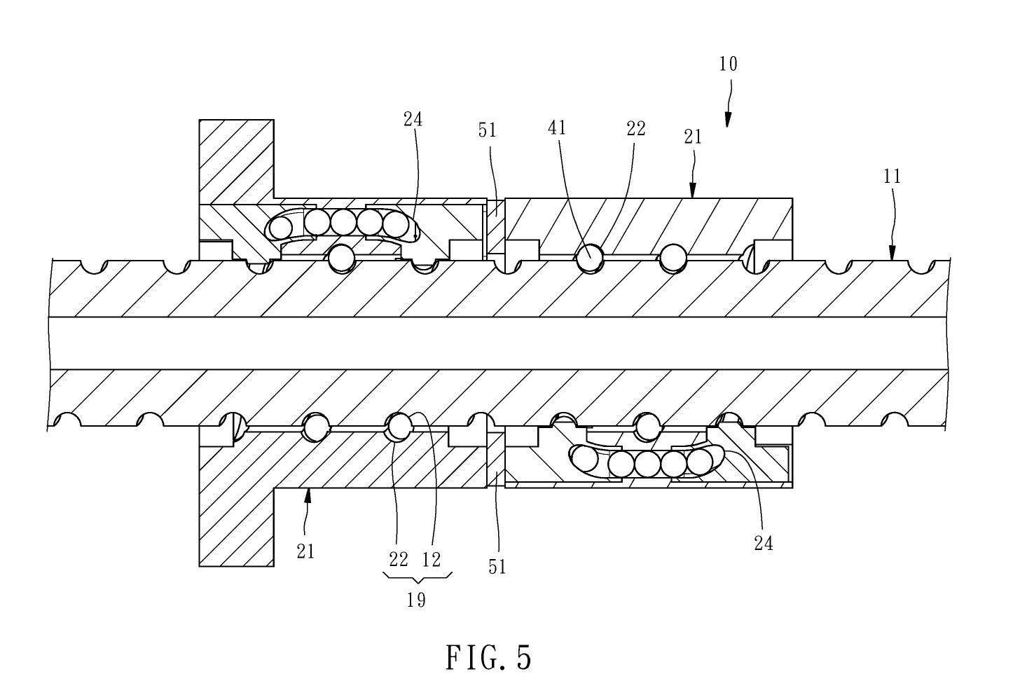

Each of the screw nuts 21 is sleeved onto the screw rod 11 and includes an internal thread 22 and an internal circulatory passage 24 at an internal periphery thereof. A spiral path 19 is formed between the internal threads 22 of the screw nuts 21 and the external thread 12 of the screw rod 11 and as shown in FIGS. 4 and 5, is linked with the circulatory passages 24 of the screw nuts 21. Each of the screw nuts 21 includes a keyway 26 at an external periphery thereof. The two keyways 26 are aligned with each other and connected with each other.

The link 31 is mounted inside the keyways 26 of the two screw nuts 21 for linking the two screw nuts 21.

The balls 41 are rollingly mounted to the spiral path 19 and each of the circulatory passages 24, for reducing the frictional resistance generated while the screw nuts 21 are working relative to the screw rod 11.

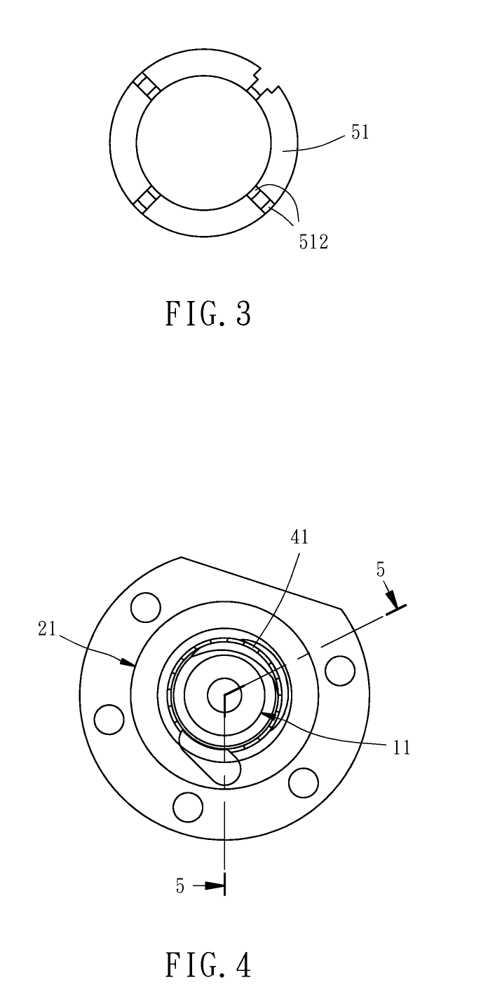

Each of the parallelism sensors 51 is arc-shaped in this embodiment but not limited to this shape in either of other embodiments. Every two adjacent parallelism sensors 51 are connected with each other via at least one connecting member 512, which are two in this embodiment, as shown in FIG. 3. When it is intended for assembly, the parallelism sensors 51 surround the screw rod 21 and every two opposite parallelism sensors 51 are mounted between face-to-face sides of the two screw nuts 21 to make the parallelism sensors 51 be squeezed by the two screw nuts 31 to sense the preload between the two screw nuts 21. After the assembly of the ball screw 10 is finalized, an external arc-shaped surface of each parallelism sensor Si is flush with the external periphery of each screw nut 21. It is worth mentioning that each of the parallelism sensors 51 is structurally not limited to what is disclosed above, e.g. the parallelism sensor 51 can be variously shaped in addition to arc-shaped, or its external arc-shaped periphery is not flush with the external periphery of the screw nut 21.

Referring to FIG. 5, when the assembly of the ball screw 10 is finalized, each of the parallelism sensors 51 can sense the preload between the two screw nuts 21 at the same time. If the preload that each of the parallelism sensors 51 senses is identical to that of the others, it will indicate that the parallelism is preferable after the assembly is finalized. On the other hand, if the preload that one of the parallelism sensors 51 senses or the preloads that more parallelism sensors 51 sense are apparently different from those of the others, the parallelism of the screw rod 11 will be deviated after the assembly is finalized, so it will need to recalibrate the screw rod 11.

In addition, in actual operation, the two screw nuts 21 can synchronously move along the axial direction of the screw rod 11 subject to the rotation of the screw rod 11. In the process of the movement of the two screw nuts 21, the preload between the two screw nuts 21 is variable and in light of the variation, the parallelism sensors 51 lead to deformation. According to the amount of the deformation, corresponsive voltage values can be outputted and converted to know whether the preload is normal or not in operation to secure that the two screw nuts 21 are well combined in the process of the movement.

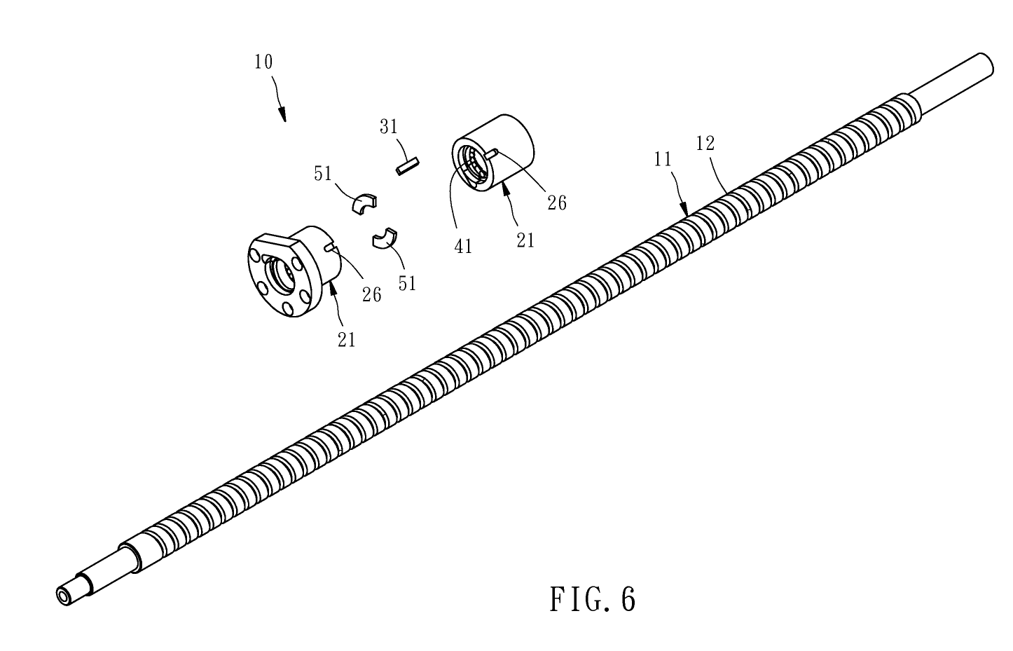

Referring to FIG. 6, the number of the parallelism sensors 51 is variable subject to actual requirement and not limited to four mounted between the two screw nuts 21 in the aforesaid preferred embodiment as long as at least two parallelism sensors 51 are oppositely mounted. between the face-to--face sides of the two screw nuts 21 and surround the screw rod 11. In this way, the parallelism of the screw rod 21 can be sensed.

In conclusion, the ball screw 10 of the present invention can monitor the voltage value outputted from each of the parallelism sensors 51 to further monitor the parallelism of the screw rod 11 in real time and to securely keep the normal preload between the screw nuts 21 in the process of the assembly to enable the whole structure to have high rigidity, high positioning precision, and high positioning stability. In addition, the places that the parallelism sensors 51 are located at are not subject to any external interference to effectively enhance the sensing accuracy.

What is claimed is:

1. A ball screw of sensing parallelism for real-time surveillance of the same, comprising:
a screw rod having an external thread;
two screw nuts sleeved onto the screw rod, each of the screw nuts having an internal circulatory passage and an internal path at an internal periphery thereof, a spiral path being formed between the internal threads and the external threads and linked with the internal circulatory passages, each of the two screw nuts having a keyway at an external, periphery thereof, the two keyways being connected with each other;
a link mounted inside the keyways;
a plurality of balls rollingly mounted within the spiral path and each of the internal circulatory passages; and
at least two parallelism sensors oppositely fixed between face-to-face sides of the two screw nuts and surrounding the screw rod.

2. The ball screw as defined in claim 1, wherein each of the at least two parallelism sensors is arc-shaped.

3. The ball screw as defined in claim 1, wherein the at least two parallelism sensors are four in number and each are arc-shaped, the four parallelism sensors surrounding the screw rod, every two adjacent parallelism sensors being connected with each other via at least one connecting member.

4. The ball screw as defined in claim 2, wherein each of the at least two parallelism sensors comprises an external arc-shaped surface that is substantially flush with the external periphery of each screw nut.

5. The ball screw as defined in claim 3, wherein each of the four parallelism sensors comprises an external arc-shaped surface that is substantially flush with the external periphery of each screw nut.
